(19) United States
(12) Patent Application Publication
(10) Pub. No.: US 2018/0286459 A1
(43) Pub. Date: Oct. 4, 2018

(54) AUDIO PROCESSING

(71) Applicant: Lenovo (Beijing) Co., Ltd., Beijing (CN)

(72) Inventor: Lianchen LI, Beijing (CN)

(21) Appl. No.: 15/727,742

(22) Filed: Oct. 9, 2017

(30) Foreign Application Priority Data
Mar. 30, 2017 (CN) 201710202750.0

(51) Int. Cl. G11B 27/031; G06F 17/30; G06F 3/16

(52) U.S. Cl. CPC G11B 27/031; G06F 3/165; G06F 17/30775; G06F 17/30778

(57) ABSTRACT

An audio processing method includes receiving an editing operation with respect to a piece of text corresponding to an audio clip of an audio file and editing the audio clip in response to the editing operation to update the audio file.

### CROSS-REFERENCE TO RELATED APPLICATION

This application claims priority to Chinese Application No. 201710202750.0, filed on Mar. 30, 2017, the entire contents of which are incorporated herein by reference.

### FIELD OF THE DISCLOSURE

The present disclosure generally relates to the field of audio editing technology and, more particularly, to an audio processing method and an electronic device.

### BACKGROUND

In conventional technologies, the general process of an audio editing solution is as follows. An audio file is played back on an electronic device. During the playback of the audio file, the user records the specific position of an audio clip/segment to be deleted, and then deletes the audio clip. The user may also record the specific position of an audio clip to be trimmed, and then trim the audio clip from the entire audio information. A plurality of trimmed audio clips may also be merged/combined to form a new audio.

However, the current audio editing solution has drawbacks. No matter trimming audio clips from the audio or deleting audio clips in the audio, the requirements for the user are relatively high. The user needs to listen to the audio file to determine whether the content of an audio clip is what the user wants, and meanwhile to record the time information corresponding to the audio clip in the audio file that the user does not want. Accordingly, the deletion can be achieved. Trimming audio clips that the user wants is almost a similar complex operation process. Therefore, for the audio editing solution in current technologies, there is lack of a faster, more efficient, and simpler interactive mode that is suitable for ordinary consumers.

### SUMMARY

In accordance with the disclosure, there is provided an audio processing method including receiving an editing operation with respect to a piece of text corresponding to an audio clip of an audio file and editing the audio clip in response to the editing operation to update the audio file.

Also in accordance with the disclosure, there is provided an electronic device including a memory storing instructions and a processor coupled to the memory. The processor executes the instructions to receive an editing operation with respect to a piece of text corresponding to an audio clip of an audio file and edit the audio clip in response to the editing operation to update the audio file.

### BRIEF DESCRIPTION OF THE DRAWINGS

In order to provide a clearer illustration of various embodiments of the present disclosure or technical solutions in conventional technology, the drawings used in the description of the disclosed embodiments or the conventional technology are briefly described below. It is apparent that the following drawings are merely example embodiments of the present disclosure. Other drawings may be obtained based on the disclosed drawings by those skilled in the art without creative efforts.

FIG. 1 is a flow chart of an audio processing method according to an embodiment.

FIG. 2 is a flow chart of a method for obtaining a new audio clip corresponding to new text according to an embodiment.

FIG. 3 is a flow chart of an audio processing method according to another embodiment.

FIGS. 4-1 and 4-2 are display effect diagrams illustrating an example of the audio processing method according to an embodiment.

FIG. 5 is an effect diagram of audio editing according to the disclosed audio processing methods.

FIG. 6 is a structural diagram of an audio processing apparatus according to an embodiment.

FIG. 7 is a block diagram of an electronic device according to an embodiment.

### DETAILED DESCRIPTION

The present disclosure provides an audio processing method and apparatus, as well as an electronic device. Through editing the text corresponding to an audio file, the editing of the audio file can be realized, thereby reducing the difficulty for audio editing. The electronic device of the present disclosure may be a mobile phone, a tablet computer, a smart TV, or the like.

In order to provide a clear and complete illustration of the present disclosure, embodiments of the present disclosure are described with reference to the drawings. It is apparent that the described embodiments are merely some of embodiments of the present disclosure, but not all of embodiments of the present disclosure. Other embodiments obtained based on the disclosed embodiments by those skilled in the art without creative efforts are intended to be within the scope of the present disclosure.

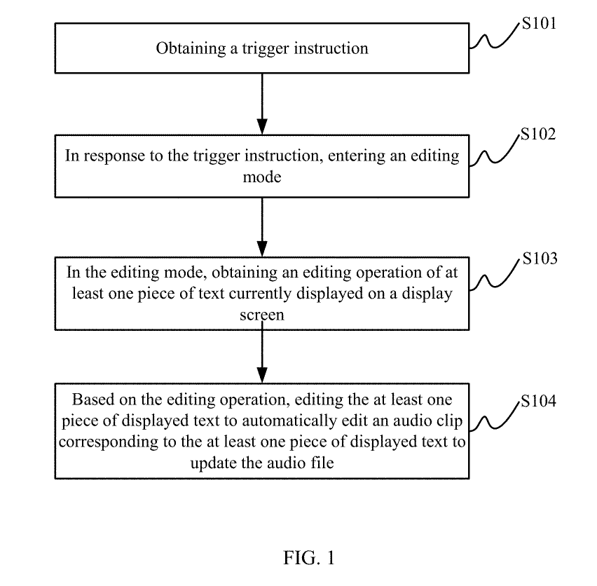

FIG. 1 is a flow chart of an audio processing method according to the present disclosure. As shown in FIG. 1, at S101, a trigger instruction is obtained.

At S102, in response to the trigger instruction, an editing mode is entered.

The trigger instruction may be generated by pressing a physical key on an electronic device, or by pressing a virtual key displayed on the electronic device. A voice acquisition module may also be used to collect a user's voice input, and the trigger instruction may be generated by recognizing the user's voice input. The electronic device responds to the trigger instruction to enter the editing mode.

At S103, in the editing mode, an editing operation of at least one piece of displayed text currently displayed on the display screen is obtained. The at least one piece of displayed text corresponds to an audio clip that is a part of an audio file.

The audio file includes voice information, which may be the voice information generated during speaking or the voice information generated during singing.

In the editing mode, the display screen of the electronic device (electronic device display screen) displays one or more pieces of text, which may be a part or all of the text corresponding to the voice information of the audio file. For example, if the audio file is a song file, the electronic device display screen displays one or more lyrics of the song. If the audio file is a file generated during speaking, the electronic device display screen displays the text corresponding to one or more sentences. The text as referred to in the present disclosure may be, for example, characters such as Chinese characters or words such as English words, French words, or German words. Accordingly, a piece of text as referred to in the present disclosure may include, for example, one or more characters, one or more words, or a combination of one or more characters and one or more words.

The text currently displayed on the electronic device display screen, also referred to as “currently displayed text,” may be a part or all of the text corresponding to the voice information of the audio file. Thus, the currently displayed text may have a corresponding audio clip, can be a part of the entire audio file. Taking the song as an example, each word in each lyric has a corresponding audio clip. Taking the user's speech as an example, each word has a corresponding audio clip.

In the editing mode, the editing operation of at least one piece of displayed text in the currently displayed text is obtained. The editing operation includes, but is not limited to, a delete operation, a replace operation, or a position moving operation.

In some embodiments, in the editing mode, the electronic device may play back the audio file and synchronously display the text corresponding to the voice information of the audio file. For example, in the editing mode, the electronic device may play back a song and synchronously display the lyrics of the song, or the electronic device may play back a recording file generated during a speech and synchronously display the contents of the speech. The electronic device may also use the voice-to-text technique to generate the text corresponding to the recording file.

At S104, based on the editing operation, the at least one piece of displayed text is edited to automatically edit the audio clip corresponding to the at least one piece of displayed text, to update the audio file.

After the editing operation of one or more pieces of text is acquired, the editing operation is performed on the one or more pieces of text, and a corresponding editing operation is performed on the audio clip corresponding to the one or more pieces of text. That is, the user can edit the text displayed on the display screen to realize the editing of the audio clips corresponding to the texts to be edited, thereby updating the audio file.

The present disclosure provides an audio processing method. Under an editing mode, a display screen displays at least one piece of text. Each of the at least one piece of displayed text has a corresponding audio clip, which is a part of an audio file. When an editing operation of one or more pieces of displayed text among the at least one piece of displayed text is acquired, the one or more pieces of displayed text are edited in response to the editing operation, and the audio clip corresponding to each of the one or more pieces of displayed text is edited correspondingly, thereby updating the audio file. Based on the disclosed audio editing method, after entering the editing mode, the user can edit the text displayed on the display screen to realize the editing of the audio clips corresponding to the text to be edited, thereby updating the audio file. It is different from the existing approach that edits the audio file directly. The user operation is simpler.

In some embodiments, the editing operation of the at least one piece of currently displayed text includes a delete operation, a replace operation, or a position moving operation. Based on different editing operations, the process of editing the at least one piece of displayed text to automatically edit the corresponding audio clip is described below.

In some embodiments, in the editing mode, if the editing operation of the at least one piece of currently displayed text is the delete operation, editing the at least one piece of displayed text to automatically edit the corresponding audio clip based on the editing operation includes deleting the at least one piece of displayed text, and deleting the audio clip corresponding to the at least one piece of displayed text to update the audio file.

For example, after entering the editing mode in response to a trigger instruction, the text currently displayed on the electronic device display screen includes “Zhe shi wo men de shi he yuan fang.” The user selects the pieces of text “shi” and “he,” and performs the delete operation. In response to the delete operation, the electronic device deletes the pieces of text “shi” and “he” from the sentence, and determines the audio clip corresponding to the text “shi” (marked as audio clip 1) and the audio clip corresponding to the text “he” (marked as audio clip 2) in the audio corresponding to the sentence. The electronic device deletes the audio clip 1 and audio clip 2. Accordingly, the audio in the audio file is updated from “Zhe shi wo men de shi he yuan fang” to “Zhe shi wo men de yuan fang.”

In some embodiments, in the editing mode, if the editing operation of the at least one piece of currently displayed text is the replace operation, editing the at least one piece of displayed text to automatically edit the corresponding audio clip based on the editing operation includes obtaining at least one piece of new text to replace the at least one piece of displayed text with the at least one piece of new text, and obtaining a new audio clip corresponding to the at least one piece of new text to replace the audio clip corresponding to the at least one piece of displayed text with the new audio clip.

That is, the replace operation indicates one or more pieces of displayed text to be replaced in the displayed text currently displayed on the display screen, and one or more pieces of new text for replacing the one or more pieces of displayed text. Based on the replace operation, the one or more pieces displayed text to be replaced, which are currently displayed on the display screen, are replaced with the obtained one or more pieces of new text. The audio clip corresponding to the one or more pieces of displayed text to be replaced is replaced with the one or more new audio clips to update the audio file.

For example, after entering the editing mode in response to the trigger instruction, the electronic device plays back a song and displays the lyrics of the song. The user selects the text to be replaced in the lyrics and enters the new text for replacing the text. For example, the text to be replaced in a lyric “wo xi huan ni” selected by the user includes the text “xi huan” and “ni.” The user enters the new text “ai” for replacing the text “xi huan,” and the new texts “lao po” for replacing the text “ni.” The electronic device determines the audio clip corresponding to the text to be replaced “ni” (marked as audio clip 3) and the audio clip corresponding to the text to be replaced “xi huan” (marked as audio clip 4). The electronic device obtains the new audio clip corresponding to the new text “lao po” (marked as audio clip 5) and the new audio clip corresponding to the new text “ai” (marked as audio clip 6). Electronic device uses the new text “ai” and “lao po” to replace the text “xi huan” and “ni” in the lyric accordingly. The audio clip 3 is replaced with the audio clip 5, and the audio clip 4 is replaced with the audio clip 6. The audio in the song is updated from “wo xi huan ni” to “wo ai lao po.”

In some embodiments, the new audio clip corresponding to the at least one piece of new text may be obtained according to one of a plurality of approaches, which are described separately below.

In some embodiments, matching is performed in a character library corresponding to the audio file based on the at least one piece of new text to determine whether the character library has at least one piece of same text. That is, whether the character library contains the at least one piece of new text. If the character library has the at least one piece of same text, using the audio clip corresponding to the at least one piece of same text in the audio file as the new audio clip corresponding to the at least one piece of new text.

The character library corresponding to the audio file refers to a character library composed of text corresponding to the voice information contained in the audio file. After the new text for replacing the displayed text is obtained, the matching of the new text in the character library is performed to determine whether the character library has the same text as the new text. If the character library has the same text as the new text, the audio clip corresponding to the same text in the audio file is used as the new audio clip corresponding to the new text.

For example, if the new text entered by the user is “xiang wang” and “ai,” the electronic device performs the matching in the character library corresponding to the audio file based on the text “xiang wang” and “ai” to determine whether the character library has the text “xiang wang” and “ai.” If the matching result indicates that the character library corresponding to the audio file has the same text “xiang wang” and “ai,” the audio clips in the audio file corresponding to the text “xiang wang” and “ai” are determined to be the new audio clips corresponding to the new text “xiang wang” and “ai.”

According to the embodiment, the audio clip corresponding to the same text as the new text is obtained from the audio file, and the audio clip is used as the new audio clip of the new text. Replacing the corresponding audio clip in the audio file with the new audio clip enables the updated audio file to provide a consistent auditory experience, such as maintaining a consistent tone.

In some languages, different words may have the same pronunciation. For example, there are a lot of homophones in the Chinese language. In this situation, the above described method can be modified, as described below.

In some embodiments, matching is performed in a character library corresponding to the audio file based on the at least one piece of new text to determine whether the character library has at least one piece of same text. If the character library has the at least one piece of same text, the audio clip corresponding to the at least one piece of same text in the audio file is used as the new audio clip corresponding to the at least one piece of new text. On the other hand, if the character library does not have same text, matching is performed in the character library corresponding to the audio file based on the at least one piece of new text to determine whether the character library has at least one piece of text with the same pronunciation as the at least one piece of new text. The at least one piece of text with the same pronunciation as the at least one piece of new text is also referred to as at least one piece of same-pronunciation text. If the character library has the at least one piece of text with the same pronunciation, the audio clip corresponding to the at least one piece of text with the same pronunciation in the audio file is used as the new audio clip corresponding to the at least one piece of new text.

According to the embodiment, the audio clip corresponding to the text with the same pronunciation as the new text is obtained from the audio file, and the obtained audio clip is used as the new audio clip corresponding to the new text. Replacing the corresponding audio clip in the audio file with the new audio clip enables the updated audio file to provide a consistent auditory experience, such as maintaining a consistent tone.

In some embodiments, the new audio clip of the at least one piece of new text can be acquired using a microphone.

That is, the audio clip corresponding to the new text is generated by the user and obtained by the microphone of the electronic device. For example, if the audio file is a song file, the user can sing the new text. The microphone of the electronic device acquires the audio generated by the user, and the audio is used as the new audio clip corresponding to the new text. As another example, if the audio file is a file generated during speaking, the user can say the new text. The microphone of the electronic device acquires the audio generated by the user, and the audio is used as the new audio clip corresponding to the new text.

In some embodiments, the at least one piece of new text can be converted into the new audio clip.

If the electronic device has a text-to-speech function, the electronic device uses the function to convert the new text into an audio clip, which is the new audio clip corresponding to the new text.

If the electronic device does not have the text-to-speech function, the electronic device may transmit the new text to a second electronic device having the text-to-speech function and receive the audio information transmitted from the second electronic device. The audio information is generated by the second electronic device utilizing the text-to-speech function to convert the new text.

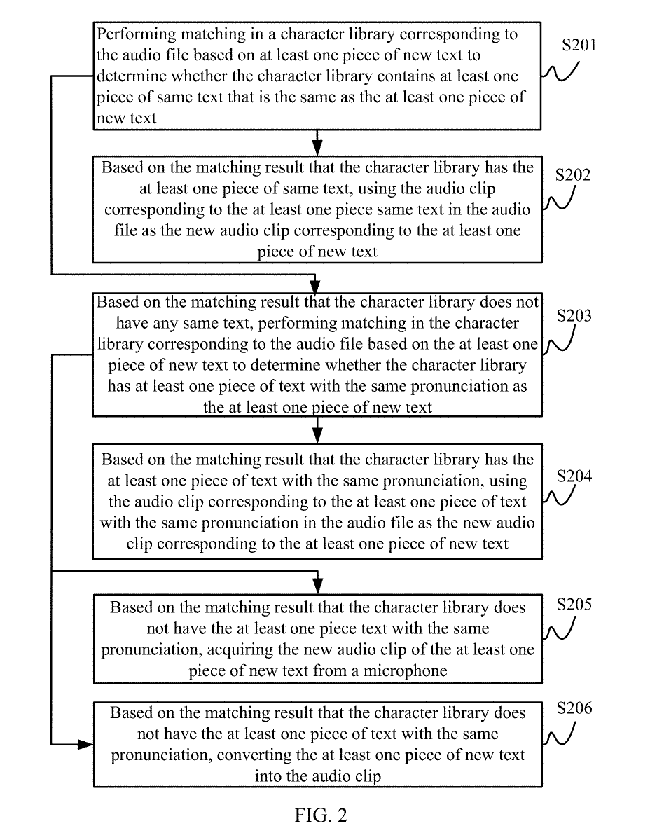

FIG. 2 shows a method for obtaining a new audio clip corresponding to new text. As shown in FIG. 2, at S201, matching is performed in a character library corresponding to the audio file based on the at least one piece of new text to determine whether the character library has at least one piece of same text.

At S202, if the character library has the at least one piece of same text, the audio clip corresponding to the at least one piece of same text in the audio file is used as the new audio clip corresponding to the at least one piece of new text.

At S203, if the character library does not have any same text, matching is performed in the character library corresponding to the audio file based on the at least one piece of new text to determine whether the character library has at least one piece of text with the same pronunciation as the at least one piece of new text.

At S204, if the character library has the at least one piece of text with the same pronunciation, the audio clip corresponding to the at least one piece of text with the same pronunciation in the audio file is used as the new audio clip corresponding to the at least one piece of new text.

At S205, if the character library does not have the at least one piece of text with the same pronunciation, the new audio clip of the at least one piece of new text is acquired from the microphone.

At S206, if the character library does not have the at least one piece of text with the same pronunciation, the at least one piece of new text is converted into the audio clip.

In some languages, very few or no words have the same pronunciation. Therefore, in some embodiments, the processes of S203 and S204 in FIG. 2 may be omitted. That is, if the character library does not have any same text, the new audio clip of the at least one piece of new text can be acquired from the microphone or converted from the at least one piece of new text.

In some embodiments, in the editing mode, when the editing operation of at least one piece of currently displayed text is the position moving operation, editing the at least one piece of displayed text to automatically edit the corresponding audio clip based on the editing operation includes adjusting the at least one piece of displayed text to a new position, cutting the audio clip corresponding to the at least one piece of displayed text from the audio file, and inserting the audio clip based on a time node corresponding to the new position in the current audio file. In some embodiments, the audio clip is inserted at the time node.

The position moving operation of the displayed text may be a dragging operation of the displayed text. The electronic device obtains the position moving operation of the displayed text and, in response to the position moving operation, adjusts the displayed text to the new position. The audio clip corresponding to the displayed text to be adjusted is cut from the audio file and inserted at the time node corresponding to the new position, thereby adjusting the position of the audio clip in the audio file.

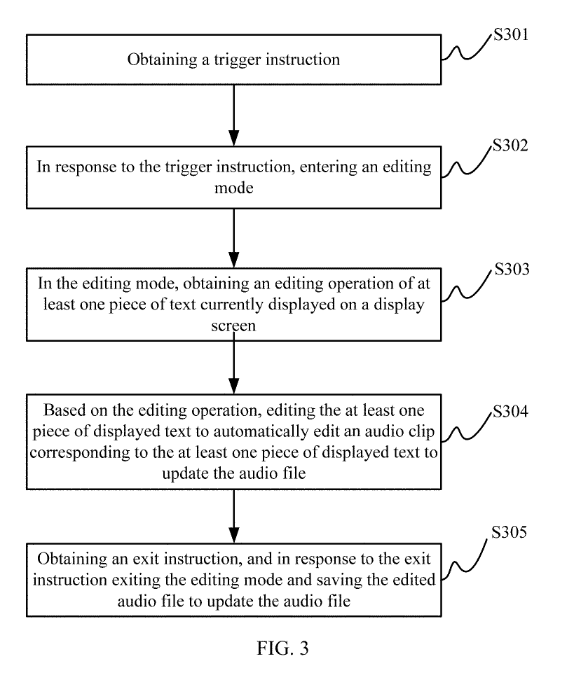

FIG. 3 is a flow chart of another audio processing method according to the present disclosure. As shown in FIG. 3, at S301, a trigger instruction is obtained.

At S302, in response to the trigger instruction, an editing mode is entered.

At S303, in the editing mode, an editing operation of at least one piece of displayed text currently displayed on the display screen is obtained. The at least one piece of displayed text corresponds to an audio clip that is a part of an audio file.

At S304, based on the editing operation, the at least one piece of displayed text is edited to automatically edit the audio clip corresponding to the at least one piece of displayed text, to update the audio file.

At S305, an exit instruction is obtained, and in response to the exit instruction, the editing mode is exited and the edited audio file is saved to update the audio file.

In the audio processing method shown in FIG. 3, based on the editing operation, the displayed text and the corresponding audio clip are edited. In response to the editing instruction, the editing mode is exited and the edited audio file is saved to update the audio file. The processes at S301 to S304 are similar to the processes at S101 to S104 described above, and thus detailed description thereof is omitted.

In some embodiments, the above-described process at S305 may be replaced with obtaining a save instruction and, in response to the save instruction, saving the edited audio file to update the audio file, and exiting the editing mode.

FIGS. 4-1 and 4-2 show an example of the audio processing method according to the present disclosure, as described in detail below.

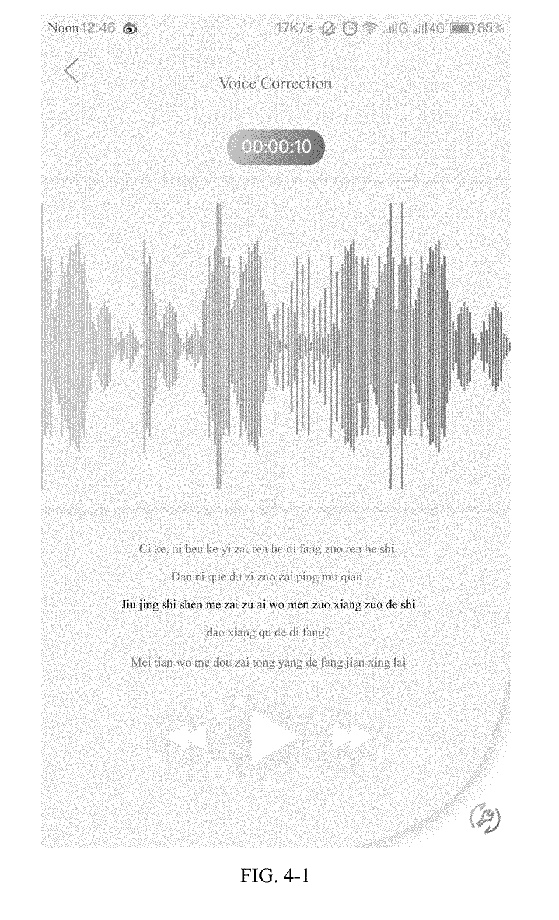

In response to the trigger instruction, the electronic device enters the editing mode. In the editing mode, the electronic device plays back the audio file. The display screen displays the texts corresponding to the speech information contained in the audio file, and displays the waveform of the audio file at the same time, as shown in FIG. 4-1. When the user selects the sentence “Jiu jing shi shen me zai zu ai wo men zuo xiang zuo de shi” displayed on the display screen, the electronic device performs the word segmentation of the sentence, and displays the result of word segmentation as “jiu jing,” “shi,” “shen me,” “zai,” “zu ai,” “wo men,” “zuo,” “xiang zuo,” “de,” and “shi,” as shown in FIG. 4-2. The user may delete one or more of the words, move the positions of one or more of the words, or add new text. According to the user's editing operation, the electronic device edits the words displayed on the display screen, and edits the audio clips corresponding to words.

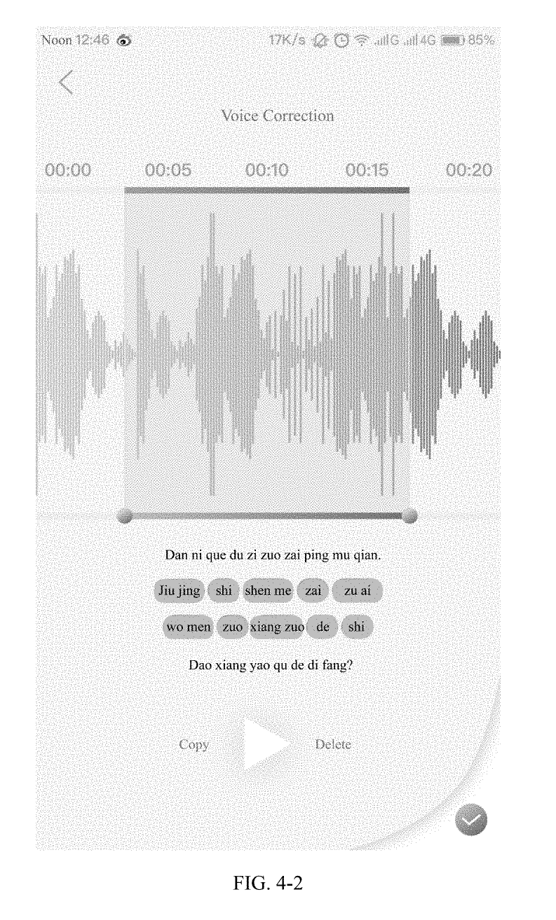

FIG. 5 shows an effect diagram of an audio editing according to the disclosed audio processing methods. As shown in FIG. 5, after the electronic device enters the editing mode, the text displayed on the display screen includes “Wo zhi dao ni bu xiang gao su wo ni suo liao jie dao de to de ba gua shi.” The user performs the editing operation of the text, and adjusts the texts to “Ni zhi dao wo bu xiang gao su to ni de ba gua shi.” At the same time, the audio clip corresponding to each piece of text is edited to update the audio file.

The present disclosure also provides an audio processing apparatus. The description of the audio processing method described above can be referred to for the description of the audio processing apparatus, and vice versa. The audio processing apparatus may be embodied as a hardware component for implementing a method consistent with the present disclosure, or may be a software code program for implementing the method consistent with the present disclosure.

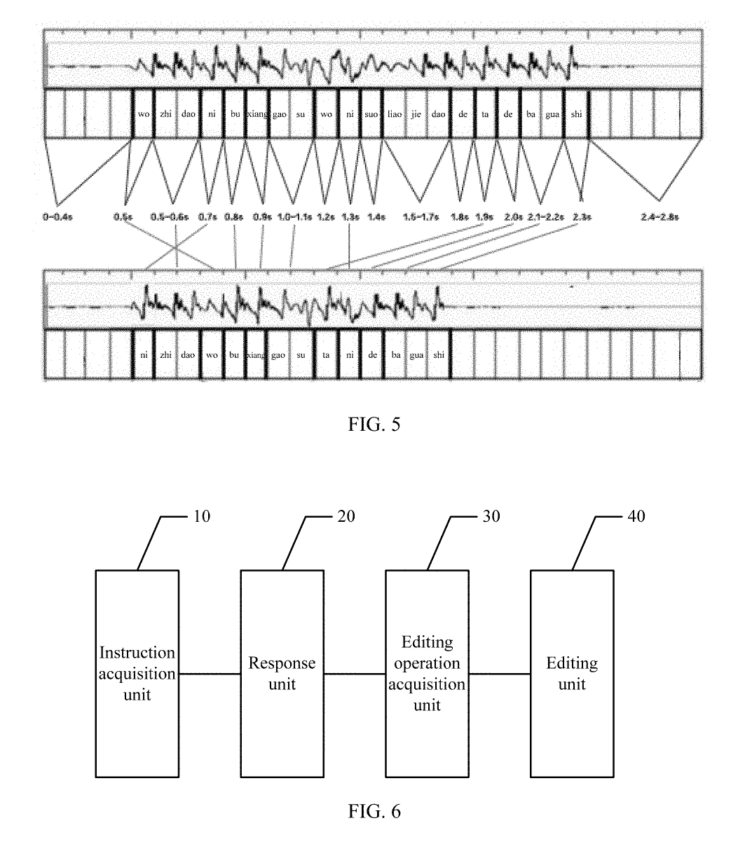

FIG. 6 is a structural diagram of an audio processing apparatus according to the present disclosure. As shown in FIG. 6, the audio processing apparatus includes an instruction acquisition unit 10, a response unit 20, an editing operation acquisition unit 30, and an editing unit 40.

The instruction acquisition unit 10 is configured to obtain a trigger instruction.

The response unit 20 is configured to, in response to the trigger instruction, cause the audio processing apparatus to enter an editing mode.

The editing operation acquisition unit 30 is configured to obtain an editing operation of at least one text currently displayed on a display screen in the editing mode. The at least one piece of displayed text corresponding to an audio clip that is a part of an audio file.

The editing unit 40 is configure to, based on the editing operation, edit the at least one piece of displayed text to automatically edit the audio clip corresponding to the at least one piece of displayed text to update the audio file.

The editing operation obtained by the editing operation acquisition unit 30 includes a delete operation, a replace operation, or a position moving operation.

In some embodiments, the editing unit 40 includes a first editing sub-unit. The first editing sub-unit is configured to delete the at least one piece of displayed text and delete the audio clip corresponding to the at least one piece of displayed text to update the audio file.

In some embodiments, the editing unit 40 includes a second editing sub-unit. The second editing sub-unit is configured to obtain at least one piece of new text and replace the at least one piece of displayed text with the at least one piece of new text, and obtain a new audio clip corresponding to the at least one piece of new text and replace the audio clip corresponding to the at least one piece of displayed text with the new audio clip.

In some embodiments, the editing unit 40 includes a third editing sub-unit. The third editing sub-unit is configured to adjust the at least one piece of displayed text to a new position, cut the audio clip corresponding to the at least one piece of displayed text from the audio file, and insert the audio clip based on a time node in the current audio file that corresponds to the new position.

The second editing sub-unit may utilize a plurality of approaches to obtain the new audio clip corresponding to the at least one piece of new text.

In some embodiments, the second editing sub-unit is configured to perform matching in a character library corresponding to the audio file based on the at least one piece of new text to determine whether the character library has at least one piece of same text. If the character library has at least one piece of same text, the second editing sub-units uses the audio clip corresponding to the at least one piece of same text in the audio file as the new audio clip corresponding to the at least one piece of new text.

In some embodiments, if the character library does not have any same text, the second editing sub-unit further performs matching in the character library corresponding to the audio file based on the at least one piece of new text to determine whether the character library has at least one piece of text with the same pronunciation as the at least one piece of new text. If the character library has the at least one piece of text with the same pronunciation, the second editing sub-unit uses the audio clip corresponding to the at least one piece of text with the same pronunciation in the audio file as the new audio clip corresponding to the at least one piece of new text.

In some embodiments, the second editing sub-unit is configured to acquire the new audio clip of the at least one piece of new text through a microphone.

In some embodiments, the second editing sub-unit is configured to convert the at least one piece of new text into the new audio clip.

In some embodiments, the above-described audio processing apparatus may also include a save unit. The save unit is configured to obtain an exit instruction and, in response to the exit instruction, exit the editing mode and save the edited audio file to update the audio file. In some embodiments the save unit is configured to obtain a save instruction and, in response to the save instruction, save the edited audio file to update the audio file and exit the editing mode.

The present disclosure also provides an electronic device including a display screen, a processor, and a memory. The display screen is configured to display data under the control of the processor. The memory is coupled to the processor and stores instructions. The processor is configured to execute the instructions to obtain a trigger instruction, enter an editing mode in response to the trigger instruction, and obtain an editing operation of at least one piece of displayed text currently displayed on the display screen in the editing mode. The at least one piece of displayed text corresponding to an audio clip that is a part of an audio file. The processor further executes the instructions to, based on the editing operation, edit the at least one piece of displayed text to automatically edit the audio clip corresponding to the at least one piece of displayed text to update the audio file.

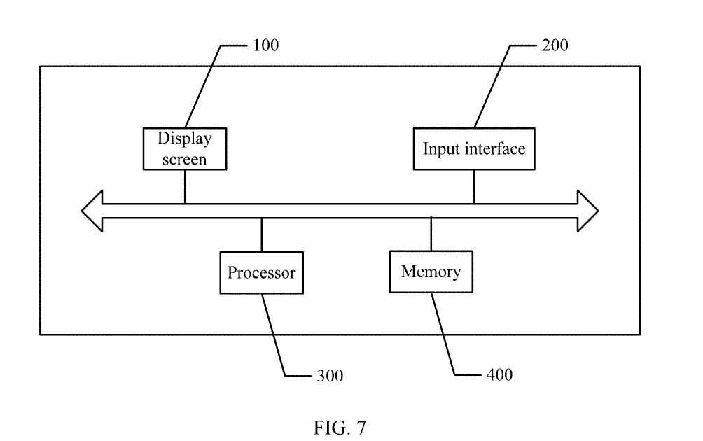

FIG. 7 is a schematic structural diagram of an electronic device. As shown in FIG. 7, the electronic device includes a display screen 100, an input interface 200, a processor 300, and a memory 400.

The display screen 100 is configured to display data under the control of the processor 300.

The input interface 200 is configured to obtain a trigger instruction. The input interface may be a hardware interface, such as a hardware interface for a hardware trigger signal generated by a user's operation of a physical key on the electronic device. The input interface may also be a software interface, such as a software interface of a software trigger signal generated by a touch sensing layer of the display screen obtaining the user's editing operation on the current software program interface (e.g. music player software or voice recording software).

The memory 400 is coupled to the processor 300 and stores instructions. The memory 300 can include a non-transitory computer-readable storage medium, and can be, for example, a read-only memory, a random access memory, a flash memory, a magnetic disk, or an optical disc.

The processor 300 can be, for example, a central processing unit (CPU), a dedicated processor, a microcontroller (MCU), or a field programmable gate array (FPGA). The processor 300 is configured to execute the instructions to, in response to the trigger instruction obtained by the input interface 200, enter an editing mode and, in the editing mode, obtain an editing operation of at least one piece of displayed text currently displayed on the display screen 100. The at least one piece of displayed text corresponds to an audio clip that is a part of an audio file. The processor 300 further executes the instructions to, based on the editing operation, edit the at least one piece of displayed text and automatically edit the audio clip corresponding to the at least one piece of displayed text to update the audio file.

After the disclosed electronic device enters the editing mode, the user can edit the text displayed on the display screen to realize the editing of the audio clips corresponding to the text to be edited, thereby updating the audio file. It is different from the existing approach, which edits the audio file directly. The user operation is simpler.

In some embodiments, the processor 300 further executes the instructions to delete at least one piece of displayed text, and delete the audio clip corresponding to the at least one piece of displayed text to update the audio file.

In some embodiments, the processor 300 further executes the instructions to obtain at least one piece of new text to replace the at least one piece of displayed text with the at least one piece of new text, and obtain a new audio clip corresponding to the at least one piece of new text to replace the audio clip corresponding to the at least one piece of displayed text with the new audio clip.

In some embodiments, the processor 300 further executes the instructions to adjust the at least one piece of displayed text to a new position, cut the audio clip corresponding to the at least one piece of displayed text from the audio file, and insert the audio clip at a time node in the current audio file corresponding to the new position.

In some embodiments, the processor 300 further executes the instructions to perform matching text in a character library corresponding to the audio file to determine whether the character library has at least one piece of same text. If the character library has at least one piece of same text, the processor 300 uses the audio clip corresponding to the at least one piece of same text in the audio file as the new audio clip corresponding to the at least one piece of new text. If the character library does not have same text, the processor 300 acquires the new audio clip of the at least one piece of new text through a microphone, or convert the at least one piece of new text into the new audio clip. The processor 300 may also use other approaches to obtain the new audio clip corresponding to the at least one piece of new text, as described above.

In some embodiments, the processor 300 further executes the instructions to obtain an exit instruction and, in response to the exit instruction, exit the editing mode and save the edited audio file to update the audio file; or obtain a save instruction and, response to the save instruction, save the edited audio file to update the audio file and exit the editing mode.

The present disclosure provides an audio processing method. That is, the audio file and the corresponding subtitles or lyrics are outputted synchronously in real-time based on a software program (e.g., music player software or voice recording software). When the user triggers the software program to enter the editing mode, the user can perform the editing operation (e.g., deleting, adding, or altering the text) to edit the subtitles or lyrics displayed on the display screen. The editing operation is performed not only to edit the displayed subtitles or the lyrics themselves, but also to edit the audio clips corresponding to the edited subtitles or the lyrics in the audio file. Finally, when the user saves or exits the editing mode, the audio file is updated and the updated audio file is different from the audio file before the update. The interactive mode according to the present disclosure is simpler, faster, and more efficient, which is more suitable for ordinary consumers.

For a detailed description of the operations performed by the disclosed processor, reference can be made to the above corresponding description of the audio processing method.

In this specification, relationship terms, such as “first,” “second,” and the like, are used merely to distinguish an entity or operation from another entity or operation, but are not intended to require or imply that there is any such physical relationship or sequence between these entities or operations. Moreover, the terms “comprising,” “including,” or any other variations thereof are intended to encompass a non-exclusive inclusion. Therefore, the process, method, article, or apparatus, which includes a series of elements, includes not only those elements but also other elements that are not explicitly listed or the elements inherent in such processes, methods, articles, or apparatus. In the absence of more restrictions, the elements defined by the statement “including a . . . ” do not preclude the presence of additional elements in the process, method, article, or apparatus including the elements.

In the present specification, the embodiments are described in a gradual and progressive manner with the emphasis of each embodiment on an aspect different from other embodiments. The same or similar parts among the various embodiments may refer to each other. Since the disclosed apparatus according to the embodiment corresponds to the disclosed method according to the embodiment, detailed description of the disclosed apparatus is omitted, and reference can be made to the description of the methods for a description of the relevant parts of the apparatus.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. An audio processing method comprising:
receiving an editing operation with respect to a piece of text corresponding to an audio clip of an audio file; and
editing the audio clip in response to the editing operation to update the audio file.

2. The method according to claim 1, further comprising:
editing the piece of text based on the editing operation,
wherein the piece of text includes one selected from the group consisting of one or more characters, one or more words, and a combination of one or more characters and one or more words.

3. The method according to claim 2, wherein editing the piece of text includes:
obtaining a piece of new text; and
replacing the piece of text with the piece of new text.

4. The method according to claim 3, wherein editing the audio clip includes:
obtaining a new audio clip corresponding to the piece of new text; and
replacing the audio clip with the new audio clip.

5. The method according to claim 4, wherein obtaining the new audio clip includes:
performing a matching in a character library corresponding to the audio file based on the piece of new text to determine whether the character library contains a piece of same text that is the same as the piece of new text;
in response to the character library containing the piece of same text, obtaining an audio clip in the audio file that corresponds to the piece of new text as the new audio clip.

6. The method according to claim 4, wherein obtaining the new audio clip includes:
acquiring the new audio clip through a microphone.

7. The method according to claim 4, wherein obtaining the new audio clip includes:
converting the piece of new text into the new audio clip.

8. The method according to claim 2, wherein editing the piece of text includes:
adjusting the at piece of text to a new position.

9. The method according to claim 8, wherein editing the audio clip includes:
cutting the audio clip corresponding to the piece of text from the audio file; and
inserting the audio clip at a time node in the audio file that corresponds to the new position.

10. The method according to claim 1, further comprising, before receiving the editing operation:
receiving a trigger instruction; and
entering an editing mode in response to the trigger instruction.

11. An electronic device comprising:
a memory storing instructions; and
a processor coupled to the memory, wherein the processor executes the instructions to:
receive an editing operation with respect to a piece of text corresponding to an audio clip of an audio file; and
edit the audio clip in response to the editing operation to update the audio file.

12. The electronic device according to claim 11, wherein:
the processor further executes the instructions to edit the piece of text based on the editing operation, and
the piece of text includes one selected from the group consisting of one or more characters, one or more words, and a combination of one or more characters and one or more words.

13. The electronic device according to claim 12, wherein the processor further executes the instructions to:
obtain a piece of new text; and
replace the piece of text with the piece of new text.

14. The electronic device according to claim 13, wherein the processor further executes the instructions to:
obtain a new audio clip corresponding to the piece of new text; and
replace the audio clip with the new audio clip.

15. The electronic device according to claim 14, wherein the processor further executes the instructions to:
perform a matching in a character library corresponding to the audio file based on the piece of new text to determine whether the character library contains a piece of same text that is the same as the piece of new text;
in response to the character library containing the piece of same text, obtain an audio clip in the audio file that corresponds to the piece of new text as the new audio clip.

16. The electronic device according to claim 14, wherein the processor further executes the instructions to:
acquire the new audio clip through a microphone.

17. The electronic device according to claim 14, wherein the processor further executes the instructions to:
convert the piece of new text into the new audio clip.

18. The electronic device according to claim 12, wherein the processor further executes the instructions to:
adjust the at piece of text to a new position.

19. The electronic device according to claim 18, wherein the processor further executes the instructions to:
cut the audio clip corresponding to the piece of text from the audio file; and
insert the audio clip at a time node in the audio file that corresponds to the new position.

20. The electronic device according to claim 11, further comprising:
a display screen coupled to the processor, wherein the display screen displays the piece of text.
